(19) United States
(12) Patent Application Publication
(10) Pub. No.: US 2025/0239708 A1
(43) Pub. Date: Jul. 24, 2025

(54) BATTERY PACK

(71) Applicant: SAMSUNG SDI CO., LTD., Yongin-si (KR)

(72) Inventors: Horyong HWANG, Yongin-si (KR); Kisung HONG, Yongin-si (KR); Junhwan HA, Yongin-si (KR)

(21) Appl. No.: 18/983,678

(22) Filed: Dec. 17, 2024

(30) Foreign Application Priority Data
Jan. 19, 2024 (KR) 10-2024-0008930

(51) Int. Cl. H01M 50/24; H01M 50/213; H01M 50/271; H01M 50/291

(52) U.S. Cl. CPC H01M 50/24; H01M 50/213; H01M 50/271; H01M 50/291

(57) ABSTRACT

A battery pack includes a plurality of battery cells, a holder accommodating the plurality of battery cells therein, a connector connected to the plurality of battery cells, a case surrounding the holder, the case being flexible and including a first communication hole, and the case being joined with the holder inserted therein and the connector pulled out of the case, and a support on the holder, the support including a second communication hole.

### CROSS-REFERENCE TO RELATED APPLICATION

The present application claims priority and the benefit of Korean Patent Application No. 10-2024-0008930, filed on Jan. 19, 2024, in the Korean Intellectual Property Office, the entire disclosure of which is incorporated herein by reference.

### BACKGROUND

### 1. Field

One or more embodiments relate to a battery pack.

### 2. Description of the Related Art

Secondary batteries are batteries designed to be rechargeable and may be used as an energy source for mobile devices, electric vehicles, hybrid vehicles, electric bicycles, and uninterruptible power supplies. Depending on the type of external device to which a secondary battery is applied, the secondary battery may be used in the form of a single battery cell or in the form of a module or pack in which multiple battery cells are connected and bundled into one unit.

Information disclosed in the background technology of the disclosure is only for facilitate understanding of the background of the present disclosure, and therefore may include information that does not constitute prior art.

### SUMMARY

According to one or more embodiments, a battery pack includes a plurality of battery cells, a holder accommodating the plurality of battery cells therein, a connector connected to the plurality of battery cells, a case surrounding the holder, the case being flexible and including a first communication hole, and the case being joined while the holder is inserted therein and the connector is pulled out of the case, and a support on the holder, the support including a second communication hole.

The case may include a body surrounding the holder, an opening at a top of the body and in fluid communication with the body, the opening accommodating insertion of the holder into the body, and the opening being joined and having opposite sides connected to each other, and wings on an outside of the body, the wings being spaced apart from each other when the opening is joined.

The opening may be joined in a direction in which the pair of wings move away from each other.

The pair of wings may be formed to face each other on one side and the other side of the body, wherein the opening may include a plurality of edges and may be joined so that the edges that are not connected to the pair of wings are close to each other.

The case may include joints around a circumference of the body, and the case may be joined along the joints.

The pair of wings may not be joined to each other, and a plurality of surfaces of the body corresponding to the joints are joined to each other.

Among the joints, a portion of the joints through which the connector passes may be joined by using an adhesive rather than thermal fusion, and the remaining portion of the joints is joined by thermal fusion.

The support may include a main frame on the holder, and a protrusion that is formed on the main frame, includes a pocket communicating with the second communication hole.

The main frame may be at an end of the holder in a height direction of the holder, and the protrusion may extend toward the center in the height direction of the holder.

The opening may be opened towards the edges of the holder.

A length of the opening may be greater than a length of the second communication hole, and a depth of the pocket may be greater than a height of the main frame.

The flow direction of air flowing into the second communication hole and the flow direction of air flowing out of the pocket may be different from each other.

The support may further include ribs extending from one surface of the holder and connected to the main frame, wherein the ribs may be on both sides of the protrusion and define the pocket on an inside together with the protrusion.

The support may include an upper support mounted on one edge of a side of the holder, and a lower support including the second communication hole.

In a state that the case surrounds the holder, the first communication hole and the second communication hole may be at a corresponding position.

The center of the first communication hole may be inside the second communication hole, and an area of the first communication hole is less than an area of the second communication hole.

The second communication hole may include a plurality of slits having a long-hole shape.

The plurality of slits may be parallel to a longitudinal direction of the holder and may be spaced apart from each other in the height direction of the holder.

The battery pack may further include a cover including a material that allows air to pass through and is waterproof and breathable and attached to the case to correspond to the first communication hole.

The cover may include a small diameter part including a material that allows air to pass through and is waterproof and breathable and a large diameter part attached to the case so as not to cover the first communication hole.

### BRIEF DESCRIPTION OF THE DRAWINGS

Features will become apparent to those of skill in the art by describing in detail exemplary embodiments with reference to the attached drawings, in which:

FIG. 1 is a diagram showing a battery pack according to embodiments;

FIG. 2 is a diagram showing a state in which a holder is inserted into a case;

FIG. 3 is a diagram showing an exploded perspective view of the holder according to embodiments;

FIG. 4 is a diagram showing a side view of the holder;

FIG. 5 is an enlarged view of a support according to embodiments;

FIG. 6 is a diagram showing a periphery of a first communication hole of the support;

FIGS. 7 and 8 are diagrams showing a joining state of the case;

FIG. 9 is a diagram showing a partially folded state of a case after the case is joined;

FIG. 10 is a diagram showing a leakage test for a battery pack; and

FIG. 11 is a diagram showing a state in which a leak prevention member is attached to a battery pack.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” if preceding a list of elements, modify the entire list of elements and do not modify the individual elements of the list.

Some embodiments of the present disclosure and methods according thereto may be understood by referring to the detailed descriptions and drawings of the embodiments. The described embodiments may have various modifications and be implemented in different forms and are not limited to the embodiments described herein. Additionally, some or all of features of various embodiments of the present disclosure may be combined with each other. Each embodiment may be implemented independently or in connection with each other. The described embodiments are provided as examples so that the present disclosure is thorough and complete, and are also intended to completely convey the spirit of the present disclosure to those skilled in the art to which the present disclosure pertains. The disclosure is subject to all modifications, equivalents, and substitutions within the spirit and technical scope of the present disclosure. Accordingly, processes, elements, and techniques that are not necessary to those skilled in the art for a complete understanding of the embodiments of the present disclosure may not be described.

Unless otherwise noted throughout the accompanying drawings and specification, like reference numerals, letters, or combinations thereof indicate the same components, and thus overlapping descriptions are omitted. Additionally, in order to clearly explain the present disclosure, parts not related to the description or parts unrelated to the description have been omitted.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present.

Further, the use of hatching and/or shading in the accompanying drawings are provided to clarify boundaries between generally adjacent elements. Accordingly, the presence or absence of hatching or shading does not indicate particular materials, material properties, dimensions, proportions, commonality between figure elements and/or other characteristics or properties of one element that is not designated, and desirable form or requirements for attributes, etc.

Various embodiments are described in the present disclosure with reference to cross-sectional examples that are schematic illustrations of embodiments and/or intermediate structures. The appearance of the drawing may therefore vary, for example as a result of manufacturing techniques and/or tolerances. The specific structural or functional description disclosed in the specification is merely an example for explaining embodiments according to the concept of the present disclosure. Accordingly, the embodiments disclosed in this specification should not be construed as being limited to the shape of the illustrated area and include, for example, deviation in shape due to manufacturing.

Areas shown in the drawings are schematic in nature and their shapes are not intended to be limiting. Additionally, as those skilled in the art will recognize, the described embodiments may be modified in various ways without departing from the spirit or scope of the present disclosure.

Numerous specific details are set forth in the specification to provide a thorough understanding of the various embodiments. However, various embodiments may be practiced without or including one or more of these specific details. In other instances, well-known structures and devices are shown in a block diagram form to avoid unnecessarily obscuring the various embodiments.

As illustrated in the drawings, to describe a relationship between one element or feature to another element or feature, spatially relative terms such as “below”, “above”, “lower”, “upper”, etc. may be used. Spatially relative terms are intended to include various orientations of a device in use or operation in addition to those shown in the drawings. For example, if the device in the drawings is turned over, other elements or features described as “below” or “lower” may face “above” the other elements or features. Accordingly, as illustrative terms, “down” and “lower” may include both up and down directions. A device may be oriented in different directions (e.g., rotated 90 degrees or in other directions) and the spatially relative descriptions used in the present disclosure should be interpreted accordingly. Similarly, if a first part is described as being disposed “above” a second part, this denotes that the first part is disposed above or below the second part.

The expression “viewed from a plane” refers to a view of an object from above, and the expression “in a schematic cross-section view” refers to a schematic cross-section taken by cutting the object vertically. The term “viewed from a side” denotes that a first object may be above, below or to a side of a second object and vice versa. Additionally, the terms “overlap” or “doubled” may include layer, stack, surface, extension, covering, or partially covering, or any other suitable term that would be understood by one of ordinary skill in the art. The expression “does not overlap” may include meanings such as “spaced apart from” or “separated from” and any other suitable equivalents recognized and understood by those skilled in the art. The term “face” may denote that a first object may directly or indirectly face a second object. If there is a third object between the first object and the second object, the first object and the second object face each other, but may be understood as indirectly facing each other.

If an element, a layer, a region, or a component is referred to as being “formed,” “connected,” or “coupled” to another element, it may be said to be formed directly on a layer, a region, or a component; formed on another component, another layer, another region, or another component; or indirectly formed on, connected to, or coupled to another component. It also may be collectively referred to direct or indirect combinations or connections of elements, layers, regions, or components and integral or non-integral combinations or connections so that one or more elements, layers, regions, or components may be present. For example, if an element, layer, region, or component is referred to as being “electrically connected” or “electrically coupled” to another element, layer, region, or component, this means that the element, layer, region, or component may be directly electrically connected or coupled, or other elements, layers, regions, or components may be present. However, “direct connection” or “direct coupling” means that one component is directly connected or combined with another component without an intermediate component or exits on another component. Additionally, in the present specification, if a part of a layer, film, region, plate, etc. is formed in another part, the formation direction is not limited to an upper direction, and includes that the part is formed on a side or bottom. Conversely, if a part of a layer, film, region, plate, etc. is formed “under” another part, it includes not only a case in which the part is “immediately below” the other part, but also a case in which another part is present between the part and the other part. Other expressions that describe relationships between components, such as “between,” “immediately between,” “adjacent to,” and “immediately adjacent to,” may be interpreted similarly. Additionally, if an element or layer is referred to as being “between” two elements or layers, it may be an only element between the two elements or layers, or there may be other elements in therebetween.

For the purposes of the specification, expressions such as “at least one or more” or “anyone” do not limit the order of individual elements. For example, “at least one of X, Y and Z”, “at least one of X, Y or Z”, “at least one selected from X, Y and Z” may include X alone, Y alone, Z alone, or any combination of two or more of X, Y, and Z. Similarly, expressions such as “at least one of A and B” and “at least one of A or B” may include A, B or A and B. In the present specification, the term “or” generally includes “and/or”, and “and/or” includes any combination of one or more related list items. For example, an expression such as “A and/or B” may include A, B, or A and B.

Although the terms “first”, “second”, “third”, etc. may be used herein to describe various elements, components, regions, layers, and/or sections, such elements, components, regions, layers, and/or cross-section are not limited by these terms. These terms are used to distinguish one element, component, region, layer, or cross-section from another element, component, region, layer, or cross-section. In this regard, a first element, component, region, layer, or cross section described below may be referred to as a second element, component, region, layer, or cross section without departing from the spirit and scope of the present disclosure. Describing an element as a “first” element may not require or imply the presence of a second or another element. Terms such as “first,” “second,” etc. may be used herein to distinguish different categories or sets of elements in the present disclosure. For clarity, terms such as “first,” “second,” etc. may refer to “first category (or first set),” “second category (or second set),” etc., respectively.

The terms used in this application are only used to describe specific embodiments and are not intended to limit the present disclosure. As used herein, singular terms are intended to include plural terms and plural terms are also intended to include the singular, unless the context clearly dictates otherwise. The terms “include,” “provide,” and “have” if used herein are meant to designate the presence of specified features, integers, or operations. These expressions do not exclude the presence or addition of one or more other functions, steps, operations, components, and/or groups thereof.

If one or more embodiments may be implemented differently, a certain process sequence may be performed differently than a described order. For example, two processes described in succession may be performed substantially simultaneously or may be performed in an order opposite to that described.

As used herein, the terms “substantially,” “about,” and similar terms are used in terms of approximation and not in terms of degree and are intended to account for inherent variations in measured or calculated values that would be recognized by a person of ordinary skill in the art. As used herein, the term “about” or “approximately” includes the stated value and denotes within a permissible range of deviation (e.g., a range of deviation due to limitations of the measurement system) for a specific value as determined by an ordinary skill in the art taking into account the corresponding measurement and associated errors. For example, the term “about” may denote within one or more standard deviations or within ±30%, 20%, 10%, or 5% of a specified value.

Unless otherwise defined, all terms used herein, including technical or scientific terms, have the same meaning as commonly understood by an ordinary skill in the technical field to which the present disclosure belongs. Terms, such as those defined in commonly used dictionaries shall be construed to have a meaning consistent with their meaning in the context of the relevant technology and/or this specification, and unless explicitly defined herein, it is not to be interpreted in an idealized or overly formal sense.

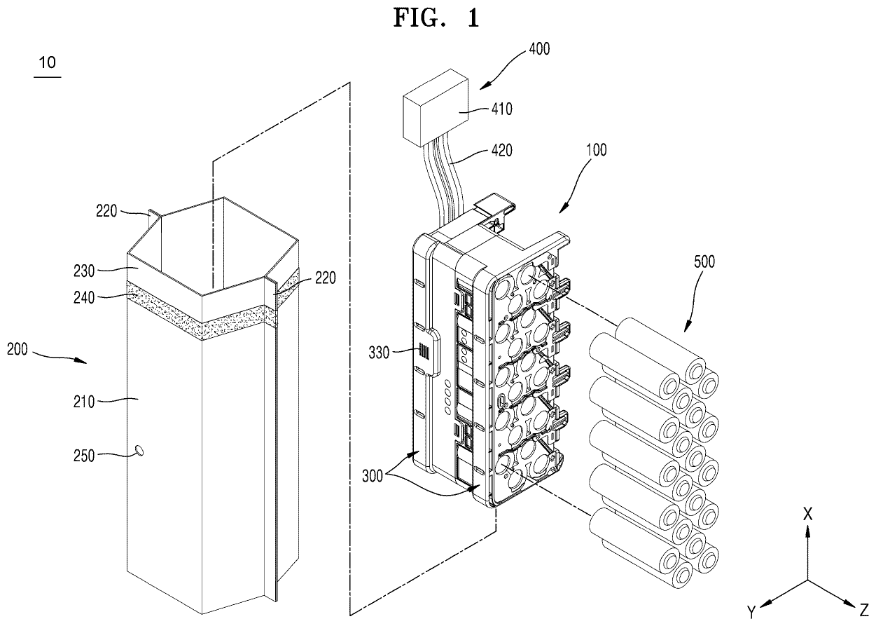

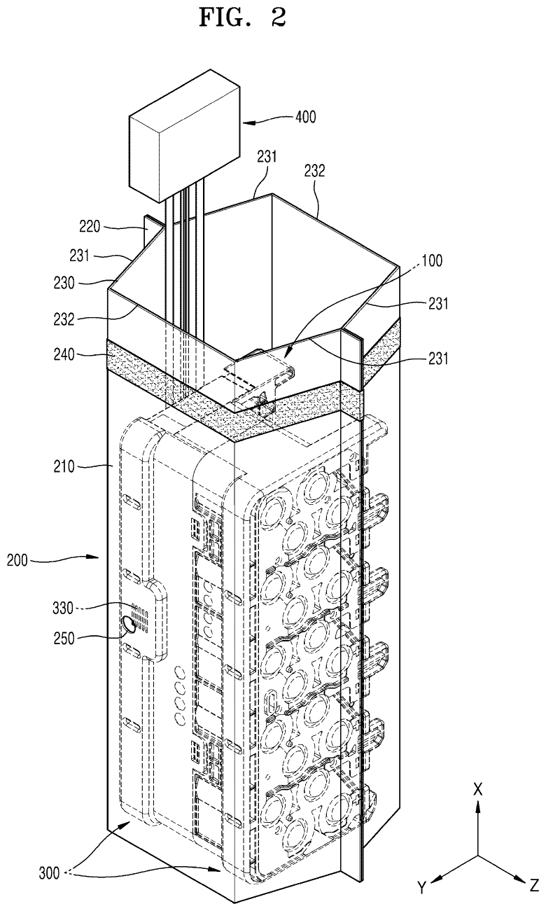

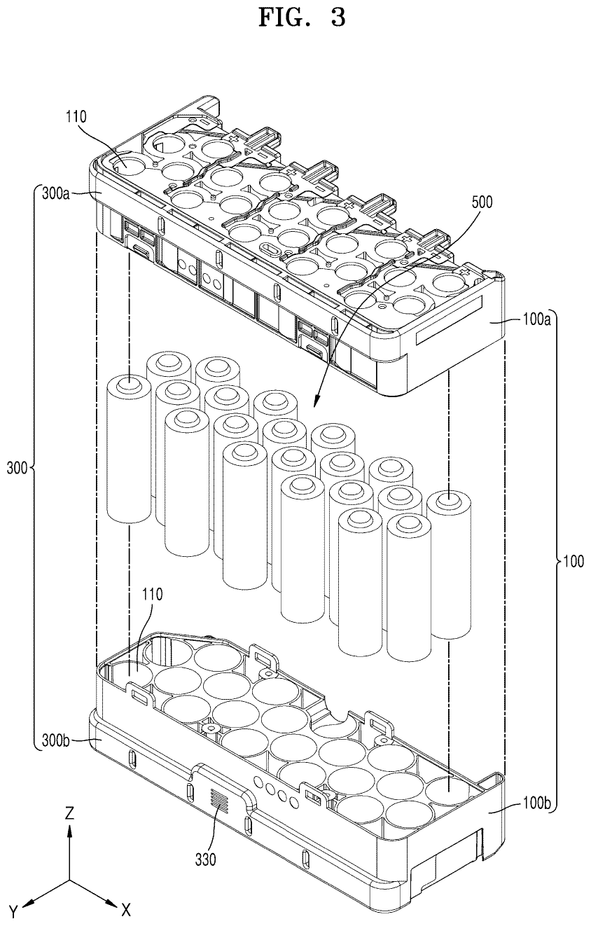

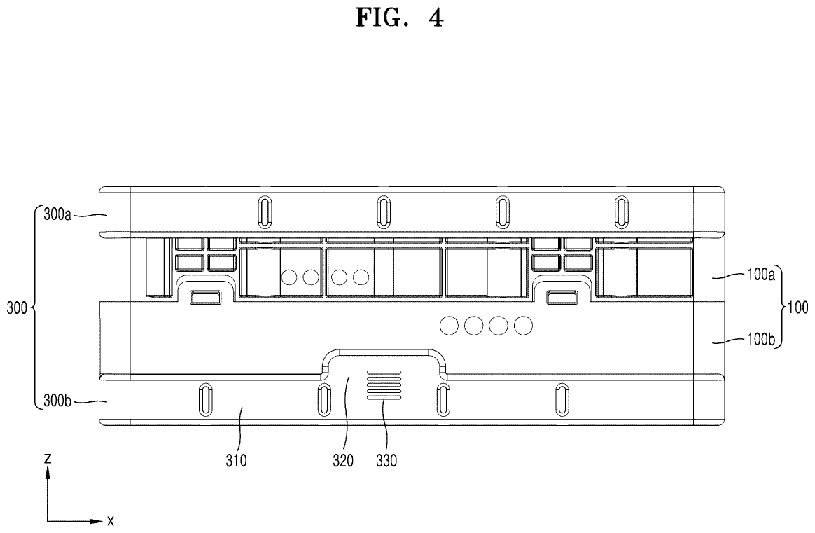

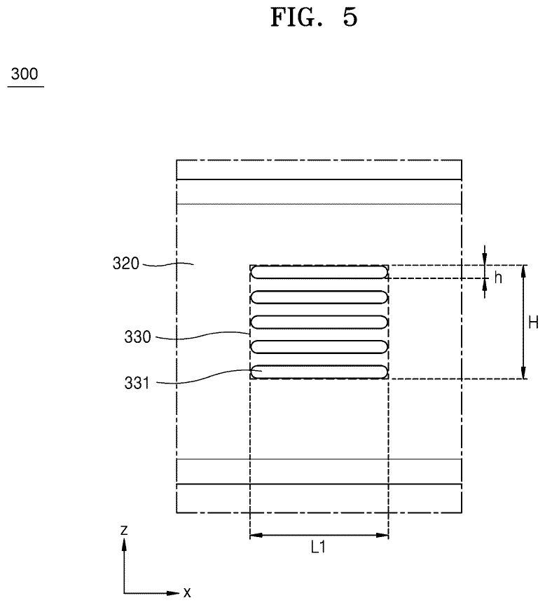

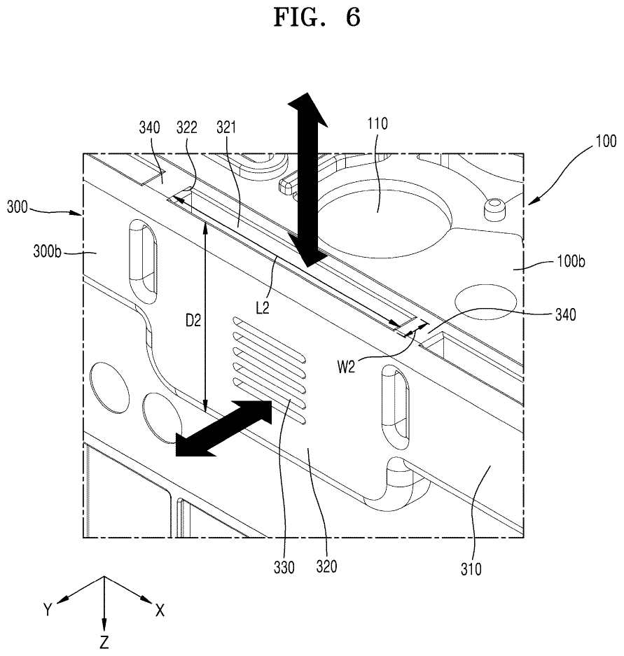

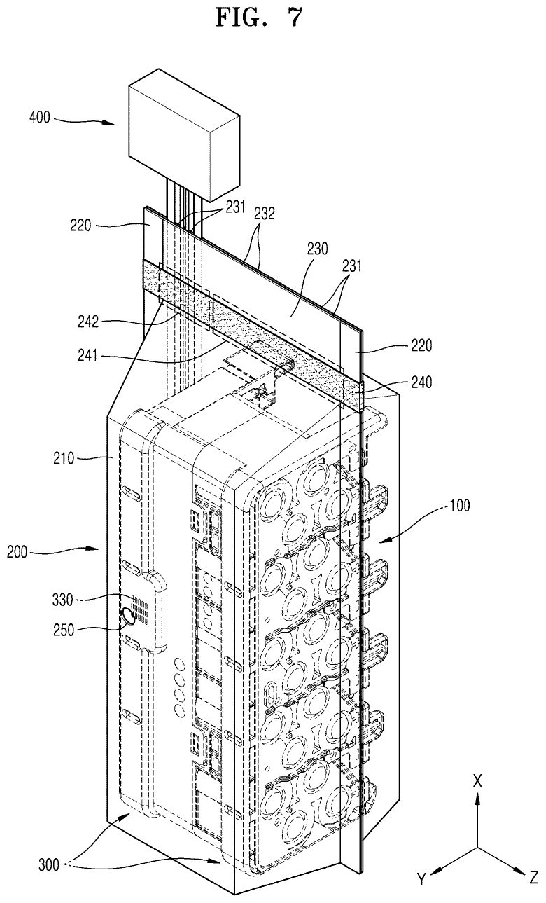

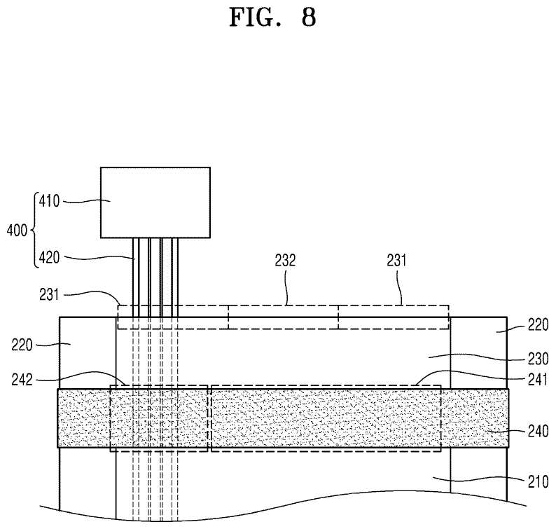

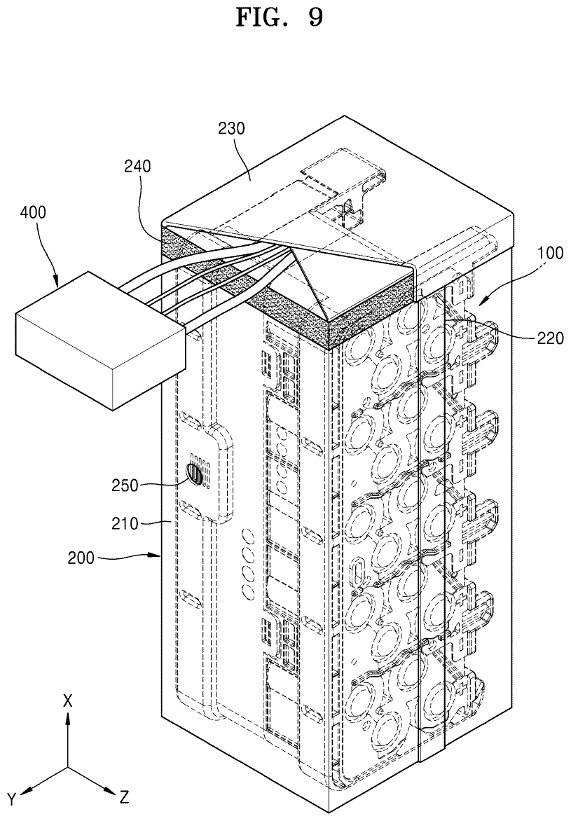

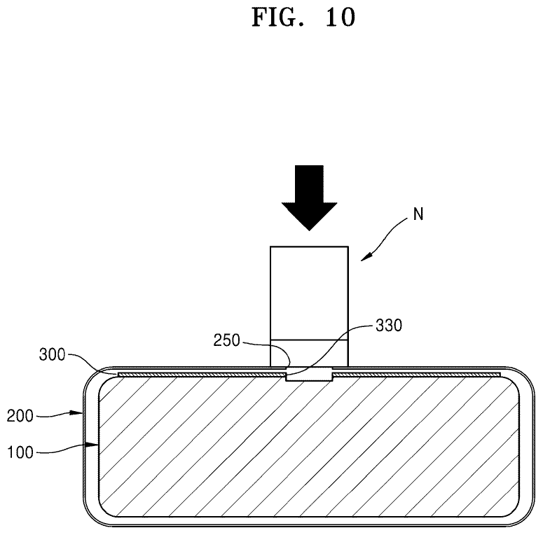

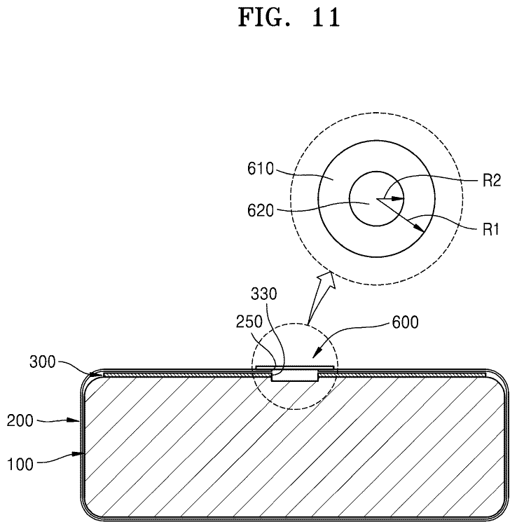

FIG. 1 shows an exploded perspective view of a battery pack 10 according to embodiments, FIG. 2 shows a perspective view of a holder 100 inserted into a case 200pf the battery pack 10, FIG. 3 shows an exploded perspective view of the holder 100, and FIG. 4 shows a side view of the holder 100. FIG. 5 shows an enlarged view of a support 300 of the holder 100, FIG. 6 shows a periphery of a second communication hole 330 of the support 300, FIGS. 7 and 8 show a joining state of the case 200, FIG. 9 shows a partially folded state of the case 200 after the case 200 is joined, FIG. 10 shows a leakage test for the battery pack 10, and FIG. 11 shows a state in which a cover 600 is attached to the battery pack 10.

Referring to FIG. 1, the battery pack 10 may be a collection of a plurality of battery cells 500 connected in series/parallel and may be included in a large application (e.g., an energy storage system (ESS)) or small and medium-sized applications (e.g., power tools and other electronic devices). The battery pack 10 may include waterproof and dustproof functions to prevent moisture or foreign substances from entering from the outside, thereby increasing reliability and durability thereof.

As shown in FIG. 1, the battery pack 10 may include the holder 100, the case 200, the support 300, a connector 400, and at least one battery cell 500 (e.g., the plurality of battery cells 500).

The holder 100 may hold and support the battery cells 500. For example, as shown in FIG. 1, a plurality of battery cells 500 may be inserted into the holder 100 and accommodated within the holder 100. The holder 100 may include openings 110 corresponding to a size and shape of the battery cell 500. For example, as shown in FIG. 3, the holder 100 may include the openings 110 having a circular shape corresponding to the battery cells 500 having a cylindrical shape. The openings 110 may have the same number as the battery cells 500.

The holder 100 may include an upper holder 100a and a lower holder 100b. For example, as shown in FIG. 3, the holder 100 may include the upper holder 100a above in a height direction of the holder 100 (e.g., a Z-axis direction in FIG. 3) and the lower holder 100b below in the height direction of the holder 100. The upper holder 100a and the lower holder 100b have corresponding sizes and shapes, and each may include the openings 110. The upper holder 100a and the lower holder 100b may be separated from and combined to each other, and each opening 110 may be coupled to each other so that one battery cell 500 is inserted therein.

The support 300 may be mounted on the holder 100. For example, the holder 100 may have an overall rectangular parallelepiped shape, and the support 300 may be mounted on at least one of opposite sides of the holder 100 (e.g., the side in a Y-axis direction of FIG. 3). Additionally, the connector 400 for connecting the battery pack 10 to another device may extend from the holder 100. For example, the connector 400 may extend from a side other than the side of the holder 100 on which the support 300 is mounted.

The case 200 may perform the waterproof and dustproof functions of the battery pack 10. For example, the case 200 may surround the holder 100 to prevent penetration of moisture or foreign matter from the outside into the holder 100 and the battery cells 500 inside the holder 100. The case 200 may have a greater size (e.g., greater width and/or length) than the holder 100, and may include an internal space in which the holder 100 is accommodated. Also, a portion of the case 200 where the holder 100 is inserted and taken out is opened (e.g., one side of the case 200 through which the holder 100 is inserted into and removed out of the case 200 may be open), and the rest may be completely closed.

The case 200 may include a flexible material. For example, the case 200 may include a textile material. For example, the case 200 may include one or more materials selected from polyamide, ceramic fiber, cellulose fiber, woven fabric, and non-woven fabric. In some embodiments, the case 200 may include a resin material. For example, the case 200 may include one or more materials selected from polyimide, polyether imide (PEI), polyethylene terephthalate (PET), polytetrafluoro ethylene, and expanded polytetrafluoro ethylene. In some embodiments, the case 200 may include both a fiber material and a resin material, or one material may be coated on the other material. For example, the case 200 may include polyvinyl chloride (PVC).

The case 200 may be partially joined while surrounding the holder 100. For example, as shown in FIG. 2, an open portion of the case 200 may be joined while the holder 100 is accommodated within the case 200. In other words, referring to FIG. 2 and FIG. 7, opposite sides of the top portion (e.g., a portion above the inserted holder 100) of the case 200 may be pushed toward each other (e.g., in the Y-axis direction of FIG. 2) to join each other (e.g., to be completely flat and flush against each other as shown in FIG. 7). For example, the open portion of the case 200 may be joined using heat fusion or adhesive, and the connector 400 may be pulled out of the case 200 while the case 200 is joined.

The case 200 may include a flexible material and may be bent or folded. For example, if the case 200 is joined, the remaining portion of the case 200 excluding the portion corresponding to (e.g., accommodating) the holder 100, i.e., a part of the case 200 above the holder 100 (in a state that the holder 100 is inserted into the case 200), may be folded toward another part (e.g., the top portions of opposite sides of the case 200 may be pushed or folded toward each other to be joined or connected to each other). In this state, the folded portion may be fixed through a fixing member, e.g., a tape.

For example, as shown in FIG. 2, the case 200 may have a hexagonal pillar shape greater than the holder 100 and may have a greater length than the holder 100, and thus, in a state that the holder 100 is inserted into the case 200, the case 200 may have a spare portion above the holder 100 (e.g., the case 200 may have an empty space above the holder 100). The case 200 may have various shapes because the case 200 includes a flexible material, and it is sufficient if a free space may be formed in a state that the holder 100 is inserted into the case 200. The spare portion of the case 200 above the holder 100 may be joined or folded (e.g., opposite sides of the case 200 in the empty space above the holder 100 may be connected to each other or folded).

The case 200 may include a body 210, wings 220, an opening 230, joints 240, and a first communication hole 250.

The body 210 may include an internal space into which the holder 100 is inserted, and may surround the holder 100. The body 210, on one side thereof, may include the opening 230 so that the holder 100 is inserted and taken out through the opening 230, and the remaining portion of the body 210, except for the opening 230, may be closed. The body 210 may have a greater size (e.g., length and/or width) than the holder 100 and may have a shape corresponding to (e.g., surrounding or accommodating) the holder 100.

The wings 220 may be formed on the outside of the body 210. The wings 220 may extend from a face or an edge of the body 210 (e.g., the wings 220 may extend away from an edge of the body 210 toward an exterior of the body 210). For example, the wings 220 may be formed, e.g., continuously, along the entire length of the body 210 (e.g., along an X-axis direction in FIG. 1). The wings 220 may extend outwardly from the edge of the body 210 and may have a width less than a surface of the body 210. For example, a pair of wings 220 may be positioned to face each other (e.g., a pair of wings 220 may be positioned at opposite sides of the body 210 and opposite sides of the opening 230, while being aligned with each other). For example, as shown in FIG. 2, the pair of wings 220 may be positioned symmetrically in the height direction of the holder 100 (e.g., in the Z-axis direction). In another example, the wings 220 may have a greater length than the holder 100 (e.g., in the X-axis direction).

As shown in FIG. 2 and FIG. 7, the joints 240 are regions in the body 210 that are pushed toward each other and are joined with each other. If the joints 240 are joined to each other (e.g., if joints 240 on opposite sides of the case 200 above the holder 100 are pushed toward each other and joined to each other), the plurality of wings 220 may be pushed farther away from each other. For example, as shown in FIG. 7, as the joints 240 are joined to each other, the pair of wings 220 may be spaced apart in a direction facing each other (e.g., in the Z-axis direction in FIG. 7).

The opening 230 may be formed in the case 200 and may be an inlet/outlet through which the holder 100 is inserted and taken out. The opening 230 may be a region defined on an inside of the body 210 by an upper edge of the body 210. For example, the opening 230 may be formed in an upper part of the case 200 above the joints 240, e.g., the joints 240 may be between a closed bottom of the case 200 and the opening 230. Additionally, while the holder 100 is inserted into the case 200, the connector 400 may be pulled out of the case 200 through the opening 230. If the holder 100 is inserted into the case 200, the opening 230 may be above the holder 100, e.g., relative to the closed bottom of the case 200. The opening 230 may include a first edge 231 and a second edge 232.

Referring to FIG. 2, the first edge 231 may be an edge in contact with the wing 220. For example, as shown in FIG. 2, the first edge 231 may be an edge adjacent to each wing 220, and two first edges 231 may correspond to one wing 220. In this regard, a first end of each of the two first edges 231 may be connected to the one wing 220. Also, each second end of the two first edges 231 may be connected to the second edge 232. If the case 200 includes a pair of wings 220, there may be four first edges 231. The two first edges 231 adjacent to any one wing 220 may face the two first edges 231 adjacent to the other wing 220. If the joints 240 are joined to each other, the first edges 231 adjacent to a same wing 220 may contact each other or may be close to each other.

The second edge 232 does not contact the wing 220 and may be connected to the first edge 231. For example, as shown in FIG. 2, a first end and a second end of the second edge 232 may be connected to two first edges 231, respectively, and may be between the two first edges 231. All edges of the opening 230, excluding the edges in contact with the wing 220 (e.g., the first edges 231) may be the second edges 232. For example, as shown in FIG. 2, a pair of the second edges 232 may face each other in one direction (e.g., the Y-axis direction in FIG. 2). If the joints 240 are joined to each other, the second edges 232 facing each other may be in contact with each other or close to each other.

For example, as shown in FIGS. 7 and 8, if the joints 240 are joined to each other, the first edges 231 and the second edges 232 may be arranged in a line between the pair of wings 220 (e.g., the Z-axis direction). As shown in FIGS. 7 and 8, two first edges 231 may be each connected to a same wing 220, and thus, four first edges 231 may be overlapped between the two wings 220. Also, two second edges 232 may be positioned between the first edges 231 by overlapping each other.

The joints 240 are a region where the body 210 is joined and may be formed continuously or discontinuously along a circumferential direction of the body 210. For example, as shown in FIG. 2, the joints 240 may be positioned below the opening 230 (e.g., the joints 240 may be between the top of the holder 100 and the opening 230), and may have a strip shape extending in the circumferential direction of the body 210. The joints 240 may be formed on the wing 220 or may replace the wing 220. In a state that the holder 100 is inserted into the case 200, the opening 230 may be closed by joining the joints 240, e.g., using an adhesive, welding, or thermal fusion. The joints 240 may include the same or different material as the body 210. For example, different surfaces of the body 210 corresponding to the joints 240 may be joined along the joints 240 in a state that the different surfaces contact (e.g., directly contact) each other. If the holder 100 is inserted into the case 200, the top of the holder 100 may be positioned below the joints 240. The connector 400 may be drawn out of the case 200 through the joined joints 240. The joints 240 may include a first portion 241 and a second portion 242.

The first portion 241 may be a part joined by thermal fusion or the like. For example, as shown in FIG. 8, the first portion 241 may be adjacent to one of the wings 220. Also, the first portion 241 may have a length corresponding to a portion of the first edge 231 adjacent to one of the wings 220 and the second edge 232.

The second portion 242 may be a portion of the joints 240 that correspond to the connector 400. For example, as shown in FIGS. 7 and 8, in a state that the joints 240 are joined, the connector 400 is pulled out of the case 200, and a portion of the connector 400 (e.g., a wire 420) may pass through the second portion 242. The second portion 242 may be joined in the same manner as the first portion 241 or may be joined in a different manner. For example, the second portion 242 may be joined with an adhesive to prevent damage to the connector 400. In some embodiments, a portion of the second portion 242 that does not overlap the connector 400 may be joined by thermal fusion, and the portion that overlaps the connector 400 may be joined with an adhesive. The second portion 242 may have a length (e.g., in the Z-axis direction) less than that of the first portion 241. For example, as shown in FIG. 8, the second portion 242 may be adjacent to one wing 220 that is not adjacent to the first portion 241. Also, the second portion 242 may have a length corresponding to a portion of the first edge 231 adjacent to one of the wings 220.

The first communication hole 250 is a hole formed in the case 200 and may be an inlet through which air flows through a nozzle N (FIG. 10) during a leakage test. The first communication hole 250 may be below the joints 240 (e.g., below a longitudinal direction of the case 200 in the X-axis direction of FIG. 2). If the holder 100 is inserted into the case 200, the first communication hole 250 may be positioned to correspond to the second communication hole 330.

The support 300 is mounted on the holder 100 and may alleviate external shock applied to the holder 100. For example, one or more supports 300 may be formed on at least one of both sides of the holder 100 (e.g., a side in the Y-axis direction of FIG. 3). One support 300 may be on each of the upper holder 100a and the lower holder 100b. The support 300 may be adjacent to an edge of the holder 100. For example, the support 300 may be adjacent to an upper edge and a lower edge of the holder 100 in the height direction of the holder 100 (e.g., the Z-axis direction in FIG. 3). The support 300 may be positioned adjacent to the upper edge of the upper holder 100a and the lower edge of the lower holder 100b, respectively. The support 300 may protrude farther than the side of the holder 100, and thus, may protect the holder 100 by first absorbing external shock applied to the holder 100.

The support 300 may include a main frame 310, a protrusion 320, a second communication hole 330, and a rib 340.

The main frame 310 may hold and support other components of the support 300 (e.g., the protrusion 320, the second communication hole 330, and the rib 340). The main frame 310 may be attached to a side of the holder 100 and may have a length corresponding (e.g., equal) to the side of the holder 100. The main frame 310 may be in contact with the holder 100.

The protrusion 320 may extend from the main frame 310, and the second communication hole 330 may be formed on one surface of the protrusion 320. For example, as shown in FIG. 4, the protrusion 320 may protrude upwardly in the height direction of the holder 100 (e.g., in the Z-axis direction) from the center of the main frame 310 in the longitudinal direction of the holder 100 (e.g., in the X-axis direction in FIG. 4). For example, the protrusion 320 may be on the lower support 300b and may protrude toward the upper support 300a. The protrusion 320 may have the second communication hole 330 formed on one surface thereof (e.g., the surface in the Y-axis direction of FIG. 3). The protrusion 320 may be spaced apart from a side of the holder 100.

The protrusion 320 may include a pocket 321 and an opening 322.

The pocket 321 may be an empty space between the protrusion 320 and the side of the holder 100. For example, as shown in FIG. 6, the pocket 321 is a region partitioned between two ribs 340 and the protrusion 320, and may communicate with the second communication hole 330 (e.g., the pocket 321 and the second communication hole 330 may be in fluid communication with each other). The opening 322 may be formed on an inlet side of the pocket 321. For example, the opening 322 may be defined between the two ribs 340 and the protrusion 320. The opening 322 may be a passage through which air in the pocket 321 may flow. For example, air injected into the pocket 321 through the second communication hole 330 may flow out of the pocket 321 through the opening 322.

The pocket 321 may have a depth D2 in the height direction of the battery pack 10 (e.g., in the Z-axis direction in FIG. 6). The depth D2 may be greater than a height of the main frame 310. Also, the opening 322 may have a length L2 in the longitudinal direction of the battery pack 10 (e.g., in the X-axis direction in FIG. 6) and may have a width W2 in a width direction of the battery pack 10 (e.g., in the Y-axis direction in FIG. 6). The length L2 may be greater than the length L1 of slits 331.

The second communication hole 330 may be formed on one surface of the protrusion 320 and may communicate with the pocket 321. The second communication hole 330 may be an inlet through which air is injected from the nozzle N if a leakage test of the battery pack 10 is performed. For example, as shown in FIG. 10, the leakage test of the battery pack 10 may be performed by injecting air into the nozzle N in a state that the first communication hole 250 of the case 200 and the second communication hole 330 of the support 300 are positioned to correspond to (e.g., overlap) each other. Injected air may pass through the first communication hole 250 and the second communication hole 330 (FIG. 10), move to the pocket 321 (FIG. 6), and then be introduced into the case 200 through the opening 322 (FIG. 6). In this state, after a certain period of time, the internal pressure of the case 200 may be measured to confirm whether the case 200 is properly sealed, and a leakage test of the battery pack 10 may be performed.

The second communication hole 330 may include the slits 331. One or more slits 331 may be formed on one surface of the protrusion 320. For example, as shown in FIG. 5, each of the slits 331 may have a long-hole shape in the longitudinal direction of the battery pack 10 (e.g., in the X-axis direction in FIG. 5). The plurality of slits 331 may be spaced apart in the height direction of the battery pack 10 (e.g., in the Z-axis direction in FIG. 5). Each slit 331 may have the length L1 and a height h. A region extending along an outline of the plurality of slits 331 may form the second communication hole 330 (e.g., the second communication hole 330 may include a region or an area including all the plurality of slits 331). The second communication hole 330 may have the length L1 and a height H. For example, as shown in FIG. 5, five slits 331 may be formed. In another example, any suitable number of slits 331, e.g., four or less or six or more, may be formed.

An area of the second communication hole 330 may be greater than an area of the first communication hole 250. For example, the area of the first communication hole 250 may be in a range from about 30% to about 80% of the area of the second communication hole 330. If an area ratio is less than 30%, a sufficient amount of air may not be injected from the first communication hole 250 to the second communication hole 330, and if the first communication hole 250 and the second communication hole 330 are not properly connected, air may not flow smoothly into the case 200. If the area ratio exceeds 80%, the amount of air leaving from the second communication hole 330 to the first communication hole 250 during the leakage test is large, and thus, a smooth leakage test may be difficult.

In a state that the case 200 surrounds the holder 100, the first communication hole 250 and the second communication hole 330 may be in positions corresponding to (e.g., overlapping) each other (see FIG. 2). For example, at least a portion of the first communication hole 250 may overlap with the second communication hole 330. For example, the center of the first communication hole 250 may be inside (e.g., may overlap a center of) the second communication hole 330.

The direction of air flow through the second communication hole 330 and the direction of air flow through the pocket 321 may be different. For example, as shown in FIG. 6, the direction of air flowing in from the second communication hole 330 and the direction of air flowing out from the pocket 321 may be different. The direction of air flowing in from the second communication hole 330 may be substantially a thickness direction of the pocket 321 or a substantially thickness direction of the battery pack 10 (e.g., in the Y-axis direction in FIG. 6). The direction of air flowing out from the pocket 321 may be substantially in a depth direction of the pocket 321 or substantially in a height direction of the battery pack 10 (e.g., in the Z-axis direction in FIG. 6). The expression “substantially” may include not only a case of air moving strictly in that direction, but also a case if the amount of air moving in that direction is relatively large. The direction of air flowing in from the second communication hole 330 and the direction of air flowing out from the pocket 321 may cross each other (e.g., may be perpendicular to each other).

The ribs 340 may be on opposite sides (e.g., both sides) of the protrusion 320 to partition the pocket 321. For example, as shown in FIG. 6, the ribs 340 may be formed on a surface of the protrusion 320 facing the holder 100. The two ribs 340 together with the protrusion 320 may define the pocket 321 therein. The opening 322 that communicates with the pocket 321 may be formed between the two ribs 340.

The support 300 may include the upper support 300a and the lower support 300b. The upper support 300a may be on the upper holder 100a, and the lower support 300b may be on the lower holder 100b. For example, as shown in FIG. 4, the upper support 300a may be adjacent to the upper edge of the upper holder 100a, and the lower support 300b may be adjacent to the lower edge of the lower holder 100b. As shown in FIG. 4, the protrusion 320 and the second communication hole 330 may be formed in the lower support 300b. In some embodiments, the protrusion 320 and the second communication hole 330 may also be formed on the upper support 300a or only on the upper support 300a.

The connector 400 may connect the holder 100 to an external device. For example, the connector 400 may include a wire 420 and a terminal 410. As shown in FIGS. 1 and 2, the wire 420 may extend from one side (e.g., bottom) of the holder 100 and may be connected to a control board or a battery management system (BMS) of the battery pack 10. Also, the wire 420 may be connected to the terminal 410, and the terminal 410 may be connected to an external device.

The battery pack 10 may further include the cover 600. The cover 600 is attachable and detachable to and from the case 200 and may cover the first communication hole 250 of the case 200. For example, as shown in FIG. 11, if it is confirmed that the case 200 is properly sealed after the leakage test is completed, the cover 600 may be attached to the first communication hole 250. The cover 600 may include an adhesive on one side and may have a greater size (e.g., greater width and length) than a size of the first communication hole 250, e.g., the cover 600 may cover and overlap the entire first communication hole 250. The cover 600 may include a material that allows air to pass through but does not allow moisture to pass through. For example, the cover 600 may include a waterproof and breathable material that allows air to pass through. A portion of the cover 600 corresponding to (e.g., overlapping) the first communication hole 250 may include a material that allows air to pass but does not allow moisture to pass through. Therefore, the cover 600 may prevents condensation from occurring inside the case 200 by flowing air through the first communication hole 250 in a state that the case 200 is joined and may block moisture flowing in from the outside.

The cover 600 may include a large diameter part 610 and a small diameter part 620. For example, as shown in FIG. 11, the large diameter part 610 may completely surround the small diameter part 620, and may be concentric with the small diameter part 620.

The large diameter part 610 is a region attached to the case 200 and may include an adhesive on one side thereof. The large diameter part 610 may have an outer radius R1 and an inner radius R2 (the outer radius R1 may be larger than the inner radius R2), and may have an annular shape (e.g., a donut shape) including an opening on an inside thereof (e.g., the opening in the large diameter part 610 may be the center of the annular shape and may have the inner radius R2). The small diameter part 620 may be in the opening of the large diameter part 610, and the inner radius R2 of the large diameter part 610 may be greater than a radius of the first communication hole 250. In a state that the cover 600 is attached to the case 200 so as to correspond to (e.g., cover or overlap) the first communication hole 250, the large diameter part 610 may not cover the first communication hole 250 (e.g., the large diameter part 610 may be attached to a region of the case 200 surrounding the first communication hole 250). The large diameter part 610 may include a material that does not allow to pass both moisture and air.

The small diameter part 620 is a region corresponding to (e.g., covering or overlapping) the first communication hole 250 and may not include an adhesive. The small diameter part 620 may include a waterproof and breathable material that allows air to pass through. The small diameter part 620 may have the inner radius R2 and may be at the opening of the large diameter part 610. In a state that the cover 600 is attached to the case 200, the center of the small diameter part 620 may be on the center of the first communication hole 250 (e.g., the centers of the small diameter part 620 and the first communication hole 250 may be aligned and overlapped).

For example, sealing and leakage test of the battery pack 10 may be performed as follows.

First, the holder 100 in which the battery cells 500 are accommodated may be inserted into the case 200 (see FIGS. 1 and 2). The holder 100 may be in a state that the support 300 is mounted thereon. For example, the holder 100 may be inserted into the case 200 so that the first communication hole 250 of the case 200 corresponds to the second communication hole 330 of the support 300. The expression “correspondence” refers to a state in which the first communication hole 250 and the second communication hole 330 overlap each other, e.g., a state that the center of the first communication hole 250 may be inside the second communication hole 330.

Next, the case 200 may be joined. In a state where the connector 400 may be pulled out of the opening 230 of the case 200, the joints 240 may be brought into contact with each other and then joined. For example, the joints 240 may be joined through thermal fusion. For example, the second portion 242 of the joints 240 corresponding to the connector 400 (e.g., the wire 420 of the connector 400) may be joined by applying an adhesive without thermal fusion. Also, the thermal fusion may be performed on the first portion 241 of the joints 240.

Joining may be performed in a state that the pair of wings 220 do not overlap each other (see FIG. 7). For example, the pair of wings 220 may be spaced apart from each other in a folded state so that the joints 240 may be brought into contact with each other. At this time, the edges of the opening 230 may also contact or become close to each other. For example, the joints 240 may contact each other while the case 200 is folded in a direction in which the pair of second edges 232 become closer to each other.

Next, the case 200 may be folded and fixed (see FIG. 9). For example, the wings 220 may be folded and fixed to a side of the case 200, and the remaining portion of the case 200 on the joints 240 may be folded and fixed. The case 200 may be fixed by using a tape or the like. Also, the joints 240 may be fixed in a folded state. For example, the joints 240 may be fixed in a folded state so that a portion of the joints 240 may be on the side of the holder 100 and the other portion may be on upper and lower surfaces of the holder 100.

Next, a leakage test may be performed (see FIG. 10). In a state that the first communication hole 250 and the second communication hole 330 correspond to each other, the nozzle N for injecting air may be positioned in the first communication hole 250. Then, air may be injected through the nozzle N. The leakage test, e.g., whether there is air leakage or not, may be performed by injecting air at a certain level of pressure and then measuring the internal pressure of the case 200 after a certain period of time. If the measured internal pressure of the case 200 satisfies a target range, it may be determined that the leakage test has been passed.

Next, the cover 600 is attached to the case 200 (see FIG. 11). The small diameter part 620 of the cover 600 may be positioned to correspond to the first communication hole 250, and the large diameter part 610 of the cover 600 may be attached to the case 200 around the first communication hole 250. Because the cover 600 (i.e., the small diameter part 620 of the cover 600) allows air to pass and includes a waterproof and breathable material, the cover 600 may prevent external moisture or foreign substances from flowing into the case 200 through the cover 600. Also, because air may pass through the cover 600, condensation within the case 200 may be prevented.

By way of summation and review, one or more embodiments include a battery pack that may improve the fixation between a battery cell and a case. The battery pack 10 may be joined after the holder 100 is inserted into the case 200, and thus, may prevent moisture or dust from entering the case 200. In the battery pack 10, the case 200 is joined so that the wings 220 do not overlap each other, thereby improving joining quality and preventing moisture from flowing into the case 200 from the outside. The battery pack 10 may easily perform a leakage test of the case 200 using the first communication hole 250 of the case 200 and the second communication hole 330 formed in the support 300 attached to the holder 100.

However, the effects that may be achieved through the present disclosure are not limited to the above-mentioned effects, and other technical effects not mentioned may be clearly understood by those skilled in the art from the description of the present disclosure described below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. A battery pack, comprising:
a plurality of battery cells;
a holder accommodating the plurality of battery cells therein;
a connector connected to the plurality of battery cells;
a case surrounding the holder, the case being flexible and including a first communication hole, and the case being joined while the holder is inserted therein and the connector is pulled out of the case; and
a support on the holder, the support including a second communication hole.

2. The battery pack as claimed in claim 1, wherein the case includes:
a body surrounding the holder;
an opening at a top of the body and in fluid communication with the body, the opening accommodating an insertion of the holder into the body, and the opening being joined and having opposite sides connected to each other; and
wings on an outside of the body, the wings being spaced apart from each other when the opening is joined.

3. The battery pack as claimed in claim 2, wherein the opening is joined in a direction in which the wings move away from each other.

4. The battery pack as claimed in claim 2, wherein:
the wings include a pair of wings, the pair of wings facing each other on one side and another side of the body, and
the opening includes a plurality of edges, the opening being joined so that the plurality of edges that are not connected to the pair of wings are close to each other.

5. The battery pack as claimed in claim 2, wherein the case includes joints along a circumference of the body, the case being joined along the joints.

6. The battery pack as claimed in claim 5, wherein the wings are not joined to each other, and a plurality of surfaces of the body corresponding to the joints are joined to each other.

7. The battery pack as claimed in claim 5, wherein, among the joints, a portion of the joints through which the connector passes includes an adhesive, and a remaining portion of the joints does not include the adhesive.

8. The battery pack as claimed in claim 1, wherein the support includes:
a main frame on the holder; and
a protrusion on the main frame, the protrusion including the second communication hole on a surface thereof, a pocket in fluid communication with the second communication hole, and an inlet opening in fluid communication with the pocket.

9. The battery pack as claimed in claim 8, wherein:
the main frame is at an end of the holder in a height direction of the holder, and
the protrusion extends toward a center in the height direction of the holder.

10. The battery pack as claimed in claim 8, wherein the inlet opening opens toward edges of the holder.

11. The battery pack as claimed in claim 8, wherein:
a length of the inlet opening is greater than a length of the second communication hole, and
a depth of the pocket is greater than a height of the main frame.

12. The battery pack as claimed in claim 8, wherein a flow direction of air flowing into the second communication hole and a flow direction of air flowing out of the pocket are different from each other.

13. The battery pack as claimed in claim 8, wherein the support further includes ribs extending from one surface of the holder and connected to the main frame, the ribs being on opposite sides of the protrusion and defining the pocket on an inside together with the protrusion.

14. The battery pack as claimed in claim 1, wherein the support includes:
an upper support mounted on one edge of a side of the holder; and
a lower support on another edge of the side of the holder, the lower support being spaced apart from the upper support and including the second communication hole.

15. The battery pack as claimed in claim 1, wherein, in a state that the case surrounds the holder, the first communication hole and the second communication hole overlapping each other.

16. The battery pack as claimed in claim 15, wherein;
a center of the first communication hole is inside the second communication hole, and
an area of the first communication hole is less than an area of the second communication hole.

17. The battery pack as claimed in claim 1, wherein the second communication hole includes a plurality of slits having a long-hole shape.

18. The battery pack as claimed in claim 17, wherein the plurality of slits are parallel to a longitudinal direction of the holder and are spaced apart from each other in a height direction of the holder.

19. The battery pack as claimed in claim 15, further comprising a cover including a material configured to allow air to pass through and is waterproof and breathable, the cover being attached to the case and overlapping the first communication hole.

20. The battery pack as claimed in claim 19, wherein the cover includes:
a small diameter part including a material that allows air to pass through and is waterproof and breathable, and a center of which overlaps a center of the first communication hole; and
a large diameter part including the small diameter part on an inside thereof and is attached to the case so as not to cover the first communication hole.
